(19) United States
(12) Patent Application Publication
(10) Pub. No.: US 2010/0311616 A1
(43) Pub. Date: Dec. 9, 2010

(54) REACTION CHIP AND METHOD OF MANUFACTURING THE SAME

(76) Inventors: Tomoyuki Ozawa, Kisarazu-shi (JP); Ming Yin, Kitakatsushika-gun (JP); Nao Azuma, Kitakatsushika-gun (JP); Masaaki Chino, Kitakatsushika-gun (JP); Yusuke Nakamura, Yokohama-shi (JP)

Correspondence Address: STAAS & HALSEY LLP, SUITE 700, 1201 NEW YORK AVENUE, N.W., WASHINGTON, DC, 20005, US

(21) Appl. No.: 12/734,263

(22) PCT Filed: Oct. 24, 2008
(86) PCT No.: PCT/JP2008/069329

§ 371 Date: Aug. 13, 2010

(30) Foreign Application Priority Data
Oct. 26, 2007 (JP) 2007-279106

(51) Int. Cl. C40B 60/12; B29C 65/48

(52) U.S. Cl. 506/39; 156/196

(57) ABSTRACT

A reaction chip includes: a first base which contains a metallic base and has a first surface; and a second base which contains a resin base and has a second surface, wherein the first surface and the second surface are joined so as to face each other; the first surface has a plurality of first recess portions and a groove portion located between the plurality of the first recess portions; the second surface has a plurality of second recess portions located corresponding to the plurality of the first recess portions; the plurality of the first recess portions and the plurality of the second recess portions are configured so as to form a plurality of reaction vessels; and the groove portion is configured so as to form a flow passage that communicates among the plurality of reaction vessels with each other.

### TECHNICAL FIELD

The present invention relates to a reaction chip and a method for producing the same.

This application claims priority on Japanese Patent Application No. 2007-279106 filed on Oct. 26, 2007, the disclosure of which is incorporated by reference herein.

### BACKGROUND ART

In the field of biochemical reactions such as DNA reactions and protein reactions, techniques called μ-TAS (Total Analysis System) and Lab-on-Chip are known in a reactor for treating a trace amount of sample solution. In these techniques, a plurality of reaction chambers and a flow passage are provided in a chip or a cartridge. Thus, analysis and reaction of a plurality of specimens can be performed. These techniques have various advantages since the amount of reagents to be treated can be decreased by miniaturization of the chip or the cartridge. Some examples of the advantages are as follows: a reduction from the conventional amount of the reagents such as strong acid and strong alkali would significantly reduce the impact on the human body and the environment. Furthermore, by reducing the consumption amount of expensive reagents used in the biochemical reaction, the cost for the reaction can be reduced.

In order to perform the biochemical reaction most efficiently using the chip or cartridge, first, different types of reagents, samples and enzymes or the like are arranged in a plurality of reaction fields. Then, reagents for starting the reaction with the sample is introduced into the reaction fields through one or a plurality of main conduits. It is necessary to perform a plurality of different reactions in such a manner. When using this technique, multiple types of specimens can be simultaneously treated with the same reagent, or one type of specimen can be simultaneously subjected to a plurality of treatments. Thus, it becomes possible to remarkably decrease the time and labor required in the prior art.

As this kind of technique, for example, there is disclosed a technique, using a microfluidic chip equipped with a liquid inlet, a flow passage and a liquid outlet or the like, wherein a portion of reagent components required for the reaction are fixed in a solid state in the flow passage of the chip by a method such as a freeze-drying or the like, and the remaining reagent components required for the reaction are delivered in a liquid state, and then these components are brought into contact with each other in the flow passage to perform the reaction (refer to Japanese Unexamined Patent Application, First Publication No. 2007-43998). There is also disclosed a sample treating apparatus wherein a loading chamber, a process chamber (reaction vessel), a process array (resin base) with a flow passage formed thereon, and a plate-shaped metal base are joined via an adhesive layer (refer to Published Japanese Translation No. 2004-502164 of the PCT Application).

### DISCLOSURE OF THE INVENTION

### Problems to be Solved by the Invention

However, when the chip described in Japanese Unexamined Patent Application, First Publication No. 2007-43998 is used, only one type of reaction can be performed by a single delivery. Therefore, in order to perform a plurality of reactions, a plurality of independent flow passages must be formed in the chip, or a valve or the like must be provided in the flow passage. As a result, there arise problems such as a large-sized chip, complicated structure, and high manufacturing cost. Therefore, this technique is not suited for practical use.

In contrast, the sample treating apparatus described in Published Japanese Translation No. 2004-502164 of the PCT Application is provided with a plurality of process chambers connected through a feeder conduit branched from one main conduit. Therefore, operations such as treating a plurality of types of specimens with the same reagent or the like can be performed. Published Japanese Translation No. 2004-502164 of the PCT Application describes an example wherein a chamber is formed by lamination of a resin base and a metal base. The document describes that, when the metal material base side is formed into a flat plate, adhesion with a heat block or the like is enhanced and suitable for the reaction with a heat cycle.

It is extremely important to accurately control the reaction temperature and temperature cycle conditions when performing biochemical reactions or the like. However, the configuration of Published Japanese Translation No. 2004-502164 of the PCT Application has a problem in that it is difficult to perform the desired reaction reliably within a short time since the chamber has insufficient heat responsiveness. Furthermore, when a different reaction is performed in each process chamber, it is necessary to enable each process chamber to serve as a sealed space by blocking the flow passages. In this sample treating apparatus, by deforming a part of the flat metal base while pushing it into the flow passage, the flow passage is blocked. However, the flow passage is not sufficiently blocked in this method. In this respect, it is difficult to perform the desired reaction.

The present invention has been made so as to solve the above problems or the like, and an object thereof is to provide a reaction chip which has a small-sized and simple structure, which is cheap, and particularly, which can reliably perform the desired reaction within a short time for a biochemical reaction or the like which requires control of the temperature, and a method for producing the same.

### Means for Solving the Problem

In order to achieve the above object, one aspect of the present invention provides the following configuration:

(1) a reaction chip including: a first base which contains a metallic base and has a first surface; and a second base which contains a resin base and has a second surface, wherein the first surface and the second surface are joined so as to face each other; the first surface has a plurality of first recess portions and a groove portion located between the plurality of the first recess portions; the second surface has a plurality of second recess portions located corresponding to the plurality of the first recess portions; the plurality of the first recess portions and the plurality of the second recess portions are configured so as to form a plurality of reaction vessels; and the groove portion is configured so as to form a flow passage that communicates among the plurality of reaction vessels with each other.

Also, the reaction chip of the present invention may be configured as follows:

(2) at least a bottom surface of the second recess portion of the second base has light transmission property.

Also, the reaction chip of the present invention may be configured as follows:

(3) the first base and the second base are joined via a heat-fusible adhesive layer.

Also, the reaction chip of the present invention may be configured as follows:

(4) a layer containing a light-absorbing material is provided on the first surface of the first base.

Also, the reaction chip of the present invention may be configured as follows:

(5) the first base contains a metallic material containing any one of aluminum, copper, silver, nickel, brass and gold.

Also, the reaction chip of the present invention may be configured as follows:

(6) the first base has a thickness within the range of 50 μm to 300 μm.

Also, the reaction chip of the present invention may be configured as follows:

(7) the second base contains a resin material containing any one of polypropylene, polycarbonate, and acryl.

Also, the reaction chip of the present invention may be configured as follows:

(8) the second base has a thickness within the range of 50 μm to 3 mm.

In order to achieve the above object, another aspect of the present invention provides the following method:

(9) a method for producing a reaction chip, including: forming, on a first surface of a first base containing a metal, a plurality of first recess portions which constitutes a portion of each of a plurality of reaction vessels, and a groove portion constituting a portion of a flow passage which communicates among the plurality of reaction vessels; forming a plurality of second recess portions which constitutes a second portion of each of the plurality of the reaction vessels on a second surface of a second base containing a resin; fixing a reagent to either the first recess portion or the second recess portion; joining the first surface and the second surface so as to face each other to form the plurality of the reaction vessels and the flow passage; filling the reaction vessel with a liquid reagent through the flow passage; and blocking the flow passage through plastic deformation of the groove portion of the first base, thereby sealing the plurality of reaction vessels.

Also, the method of the present invention may be performed as follows:

(10) the first surface includes a layer containing a light-absorbing material, and a heat-fusible adhesive layer; the second base contains a resin material having light transmission properties; and the first surface and the second surface are arranged so as to contact while facing each other, and then the first base and the second base are joined by irradiating with a laser beam from the side of the second base.

Also, the method of the present invention may be performed as follows:

(11) the first recess portion and the groove portion are formed by press forming or drawing process.

### ADVANTAGEOUS EFFECTS OF THE INVENTION

The reaction chip according to one aspect of the present invention can realize a small-sized and cheap reaction chip with a simple configuration. Using a plurality of reaction vessels, multiple types of specimens can be treated with the same reagent. Also, one type of specimen can be subjected to a plurality of treatments.

The reaction vessel is formed by combining a recess portion of a first base and a recess portion of a second base. By appropriately setting the volume of both recess portions, the capacity of the reaction vessel can be sufficiently ensured. Also, the design flexibility such as capacity or shape or the like of the reaction vessel can be enhanced. When compared with a conventional chip using a flat metal plate (sample treating vessel of Published Japanese Translation No. 2004-502164 of the PCT Application), the ratio of the surface area of the metal portion to the entire surface area of the reaction vessel increases by providing a recess portion on the first base made of metal. Therefore, heat conductivity of the entire reaction vessel is improved and heat responsiveness is improved. As a result, the reaction temperature and temperature cycle conditions can be accurately controlled and the desired reaction can be performed reliably within a short time. Furthermore, when each reaction vessel is sealed by blocking the flow passage, for example, the flow passage can be blocked by plastic deformation of the groove portion of the first base through application of a mechanical external force. Therefore, the flow passage can be reliably blocked and thus the desired reaction can be obtained.

With the configuration wherein a bottom surface of at least the recess portion of the second base has light transmission properties, when a fluorescence reaction or the like is detected and measured upon the reaction of the reagent, detection and measurement can be performed in a state while the reaction chip is being filled with a reactant. Therefore, the labor and time of the operation can be reduced and also contamination with PCR products can be prevented, leading to superior workability.

With the configuration in which the first base and the second base are joined via a heat-fusible adhesive layer, the first base and the second base can be fixed easily and firmly by applying energy such as light or heat or the like.

With the configuration in which a layer containing a light-absorbing material is provided on one surface of the first base, when detection and measurement of the fluorescence reaction or the like are performed from the side of the second base, irregular reflection on the surface of the first base can be suppressed and thus detection and measurement can be performed more accurately. Furthermore, when a resin material constituting the second base has light transmission properties and a heat-fusible adhesive layer is interposed between the first base and the second base, a laser beam irradiated from the side of the second base is absorbed in the first base and then converted into heat, and thus the first base and the second base can be joined by heat fusion. That is, the operation of joining the first base and the second base can be performed by a simple method such as irradiation with a laser beam.

When a metallic material containing any one of aluminum, copper, silver, nickel, brass and gold is used as the first base, a first base having superior heat conductivity can be made.

When the first base has a thickness within the range of 50 μm to 300 μm, it is possible to satisfy both processability and heat conductivity of the first base for the following reasons. When the thickness of the first base is less than 50 μm, it is difficult to form the recess portion or groove portion by a simple method such as press forming or drawing process or the like and also sufficient strength cannot be obtained. In contrast, when the thickness of the first base is more than 300 μm, heat capacity increases and heat responsiveness decreases.

When a resin material containing any one of polypropylene, polycarbonate and acryl is used as the second base, satisfactory light transmission properties, heat resistance and strength can be ensured.

When the second base has a thickness within the range of 50 μm to 3 mm, satisfactory light transmission properties, heat resistance and strength can be ensured and processing of the recess portion can be reliably performed. The second base can be made by a method such as injection molding or vacuum molding or the like.

By the method for producing a reaction chip according to one aspect of the present invention, a small-sized and cheap reaction chip with a simple configuration can be easily produced. Since the flow passage can be blocked by plastic deformation of the groove portion of the first base through application of a mechanical external force or the like, the flow passage can be blocked reliably and easily.

With the configuration in which a layer containing a light-absorbing material and a heat-fusible adhesive layer are formed on one surface of the first base, if a resin material having light transmission properties is used as the second base and after the second base and the first base are laid one upon the other so that one surface of the first base and one surface of the second base face each other, the first base and the second base are joined by irradiating with a laser beam from the second base, the operation of joining the first base and the second base can be performed by a simple method of irradiation with laser beam.

When the recess portion and groove portion of the first base are formed by press forming or drawing process, a protrusion portion is formed on the surface opposite the surface on which the recess portion and groove portion of the first base are formed. Therefore, the surface area of the surface opposite the surface on which the recess portion and groove portion of the first base are formed increases, and thus, it is possible to increase heat transfer efficiency upon heating or cooling the reaction chip from the outside.

### BRIEF DESCRIPTION OF THE DRAWINGS

FIG. 1 is a perspective view showing a reaction chip according to one embodiment of the present invention.

FIG. 2 is a plan view showing a resin base constituting the reaction chip.

FIG. 3 is a plan view showing a metal base constituting the reaction chip.

FIG. 4 is a cross-sectional view taken along line A-A′ of FIG. 1.

FIG. 5 is a cross-sectional view taken along line B-B′ of FIG. 1.

FIG. 6 is a cross-sectional view showing a state where a portion of a flow passage of the reaction chip is occluded.

### BRIEF DESCRIPTION OF THE DRAWINGS

1: Reaction chip
2: Resin base (Second base)
3: Metal base (First base)
4: Reaction vessel
5: Channel
6: Recess portion (of resin base)
9: Resin coating layer (Adhesive layer)
11: Recess portion (of metal base)
12: Groove portion
S: Reagents
L: Liquid reagent

### BEST MODE FOR CARRYING OUT THE INVENTION

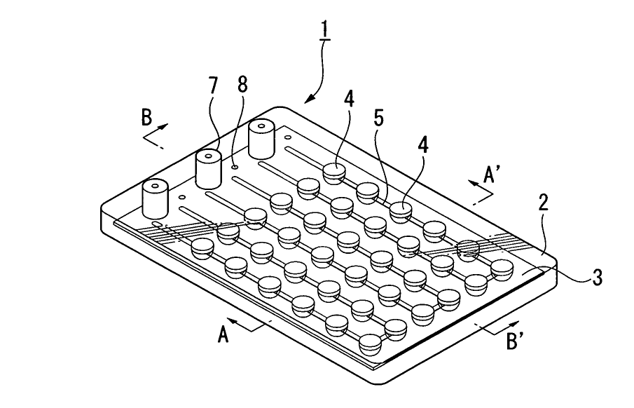

One embodiment of the present invention will now be descried with reference to FIG. 1 to FIG. 6.

In the present embodiment, an example of a reaction chip for identification and analysis of single nucleotide polymorphisms is described.

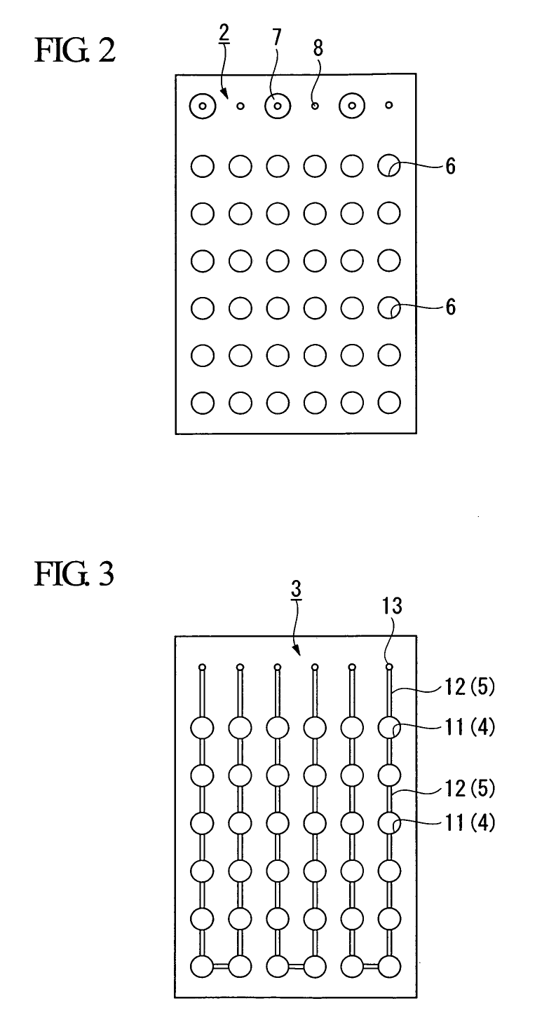

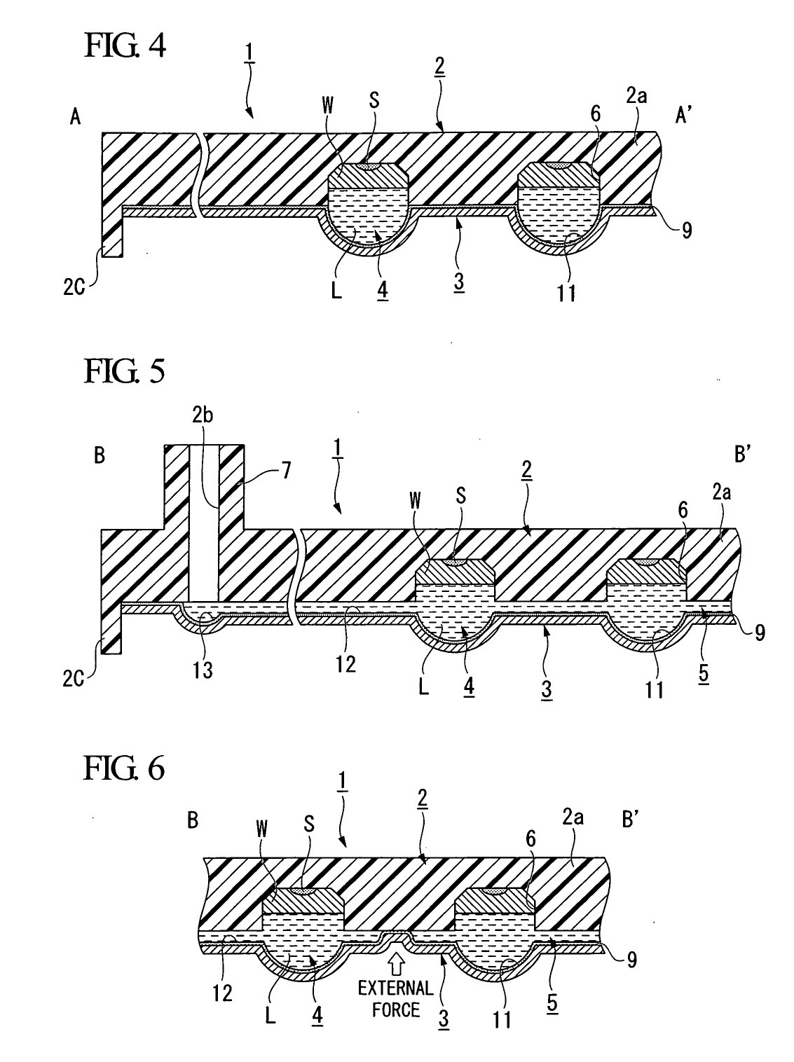

FIG. 1 is a perspective view showing a reaction chip of the present embodiment. FIG. 2 is a plan view showing a resin base (second base) constituting the reaction chip. FIG. 3 is a plan view showing a metal base (first base) constituting the reaction chip. FIG. 4 is a cross-sectional view taken along line A-A′ of FIG. 1. FIG. 5 is a cross-sectional view taken along line B-B′ of FIG. 1. FIG. 6 is a cross-sectional view showing a state where a portion of a flow passage of the reaction chip is occluded. For convenience of description, the side of the resin base located at the upper side at the time of fluorescence reaction detection or measurement is referred to as the “upper side”, while the side of the metal base located at the lower side is referred to as the “lower side”.

A reaction chip 1 of the present embodiment has a rectangular planar shape measuring about several tens of mm in both length and width, and about several mm in thickness, as shown in FIG. 1. The reaction chip 1 includes a resin base 2 (second base) and a metal base 3 (first base) fitted into the under side of the resin base 2. The largest feature of the reaction chip 1 of the present embodiment is that recess portions constituting reaction vessels 4 are formed on the resin base 2, and recess portions constituting reaction vessels 4 and groove portions constituting flow passages 5 are formed on the metal base 3.

As the resin base 2, for example, a polypropylene plate material can be used, the plate material having a thickness of about 50 μm to 3 mm which is superior in light transmission properties, heat resistance and strength as a chip base for identification analysis. In addition, a resin material such as polycarbonate or acryl or the like may also be used. On the under side of the resin base 2, as shown in FIG. 2, a plurality of (36 recess portions, 6 lines, 6 rows in the present embodiment) recess portions 6 constituting a portion of reaction vessels 4 are formed. These recess portions 6 are not communicated with each other and are isolated. The cross-sectional shape of the recess portions 6 is, as shown in FIG. 4 and FIG. 5, a columnar shape at the proximal side of the under side of the resin base 2, or a circular truncated cone shape at the distal side.

At one end of the top surface (the surface opposite the surface on which recess portions 6 are formed) of the resin base 2, a plurality of (3 inlets in the present embodiment) liquid reagent inlets 7 are provided, as shown in FIG. 1 and FIG. 2. As shown in FIG. 5, the liquid reagent inlets 7 are communicated with a through-hole 2b piercing through a top plate portion 2a of the resin base 2, and are formed in the form of an upwardly extruding cylinder. At a side of the liquid reagent inlets 7, as shown in FIG. 1 and FIG. 2, minute through-holes 8 are provided and the through-holes 8 are packed with filters (not shown). The filter has the function of passing air therethrough while a liquid reagent flows, thereby smoothly passing the liquid reagent therethrough. When the liquid reagent flowing from the flow passage reaches the through-holes 8, the filter fulfils the function of blocking the liquid reagent and preventing the liquid reagent from flowing out. At the edge of the top plate portion 2a of the resin base 2, as shown in FIG. 4 and FIG. 5, a frame portion 2c which is suspended downwardly from the top plate portion 2a, is provided. The metal base 3 is fixed so as to fit into the inside of the frame portion 2c.

As the metal base 3, for example, an aluminum sheet having a thickness of about 0.1 mm (100 μm) can be used. Only one surface of this aluminum sheet is subjected to resin coating.

The thickness of the metal base 3 is preferably from about 50 μm to 300 μm. A resin coating layer 9 (adhesive layer) is an adhesive layer which is made of polypropylene having a melting point of about 130° C. as a main material and is also heat-fusible with the metal base 3 and the resin base 2. The thickness of the resin coating layer 9 is about 0.07 mm. As the material of the metal base 3, copper, silver, nickel, brass and gold or the like may be used, in addition to aluminum. All of these metals are metals having comparatively high heat conductivity. In any event, since the resin coating layer 9 is formed on the surface of the metal base 3, it is not necessary to take the chemical resistance of the metal base into consideration when the material is selected.

When the resin coating layer 9 is formed on the aluminum sheet, an anchor layer (not shown) is formed as a base of the resin coating layer 9. The anchor layer contains carbon black (light-absorbing material) kneaded therein. Since the resin coating layer 9 is transparent, the surface on the side on which the resin coating layer 9 of the aluminum sheet is formed, has a black external appearance. Alternatively, in place of the addition of carbon black to the anchor layer, carbon black may be added to the resin coating layer 9, or the surface of the resin coating layer 9 may be painted black.

On the top surface of the metal base 3, a plurality of (36 recess portions in the present embodiment) recess portions 11 constituting a portion of the reaction vessel 4 is formed. These recess portions 11 are formed at positions corresponding to recess portions 6 of the resin base 2 when the metal base 3 and the resin base 2 are positioned. Unlike the recess portion 6 of the resin base 2, the cross-sectional shape of the recess portion 11 is, as shown in FIG. 4 and FIG. 5 and other figures, a generally semispherical shape.

Between a plurality of recess portions 11, groove portions 12 constituting portions of flow passages 5 are formed.

The reaction chip 1 of the present embodiment has 3 pairs of flow passages 5, as shown in FIG. 1 and FIG. 3. Twelve recess portions 11 (reaction vessels 4) are serially communicated with a pair of flow passages 5. At the position corresponding to each liquid reagent inlet 7, a small recess portion 13 is formed. The groove portion 12 is also formed between the recess portion 13 and the recess portion 11. Therefore, the liquid reagent injected from each liquid reagent inlet 7 flows through the flow passage 5, sequentially fills 6 reaction vessels 4 and returns back through the flow passage 5. Thus, the liquid reagent sequentially fills the remaining 6 reaction vessels 4 and is blocked by the filter of the through-holes 8.

The method for producing a reaction chip of the present embodiment will now be described in accordance with the procedure actually performed by the present inventors.

On one surface of an aluminum sheet, an anchor layer and a resin coating layer 9 are sequentially formed to form a base sheet. The base sheet is subjected to press forming or drawing process to form a plurality of recess portions 11 and groove portions 12. In the present embodiment, the recess portions 11 are not formed by grinding or etching a thick aluminum plate, but is formed by press forming or drawing process of a thin aluminum sheet. Therefore, a metal base 3 is obtained in which the rear side is not flat and protrusion portions are formed on the rear side as a result of reflection of the shape of the recess portions of the front side.

On the other hand, a resin base 2 having a plurality of recess portions 6 is made by injection molding or vacuum molding or the like.

As shown in FIG. 4 and FIG. 5, different types of SNP probes are fixed in the plurality of recess portion 6 of the resin base 2 and an enzyme is dropped using a pipette. The resin base 2 is centrifuged by a centrifugal apparatus at 2,500 rpm for about 15 minutes and then dried in a state of a flat liquid level. Furthermore, a wax W is melted on a hot plate and dropped using a pipette so as to cover the dried reagents S. At this time, the wax W is solidified within several seconds. The wax W fulfils the role of fixing the reagents S in the recess portions 6 of the resin base 2 and also fulfils the role of preventing mixing immediately after being brought into contact with the liquid reagent L.

Next, the resin base 2 fixed with the reagents S and the metal base 3 are laid one upon the other so that the surfaces with the recess portions 6, 11 formed thereon face each other, and heat is applied so as to increase the temperature of the metal base 3 to 130° C. or higher. As a result, the resin coating layer 9 on the surface of the metal base 3 is melted and thus the resin base 2 and the metal base 3 are fused. In the above steps, a chip including a plurality of reaction vessels 4 and a flow passage 5 is completed.

In the present embodiment, as the technique of laminating the resin base 2 and the metal base 3, a technique called heat sealing can be used, in which the lamination portion is heated using a heated metal block. Alternatively, when the anchor layer containing carbon black is formed on the surface of the metal base 3 to be joined with the resin base 2, light is effectively absorbed when the metal base 3 is irradiated with light. Accordingly, the resin coating layer 9 is efficiently melted by, for example, irradiating with an infrared photodiode laser beam having a wavelength of about 900 nm. The resin base 2 and the metal base 3 can be laminated also by this method.

As shown in FIG. 4 and FIG. 5, to each reaction vessel 4 of the chip thus obtained, liquid reagent L such as specimens such as diluted extracted genome, PCR products, or reaction reagents used for performing an invader reaction (registered trade mark) or the like, is delivered.

After the delivery, an aluminum block having a plurality of protrusions is positioned so as to bring each protrusion into contact with a middle part of the flow passage 5 (rear side of groove portions 12 of the metal base 3), and a force of about 4 Kgf per one position is applied by a ball screw of a stepping motor drive. As a result, as shown in FIG. 6, the groove portions 12 of the metal base 3 are plastically deformed and thus the flow passages 5 communicating each reaction vessel 4 are occluded. At the same time, by heating the aluminum block in advance to 130° C. or higher, the metal base 3 and the resin base 2 are fused by the resin coating layer 9 at the plastically deformed position. Then, each reaction vessel 4 is completely divided to form a sealed space.

Thus, when different types of reagents S are fixed to each reaction vessel 4 of the reaction chip 1, the identification reaction of various types of SNPs can be simultaneously performed in the reaction chip.

As the method of dividing each reaction vessel 4, a method other than the above method may also be used. For example, an aluminum block may be screwed at the tip of a soldering iron and each groove portion 12 may be crushed by hand in a state of being heated to 130° C. or higher.

After each reaction vessel 4 is in a independent state, the temperature of the reaction chip 1 is controlled to a predetermined temperature (the melting point of the wax W or higher). As a result, the solidified wax W is melted and the SNP probes, specimens and enzyme are mixed in the reaction vessel 4, and thus the reaction is individually initiated in each reaction vessel 4. In order to control the temperature of the reaction chip 1, a heater composed of a heating wire or the like and a Peltier element may be arranged at the side of the metal base 3.

At this time, since the resin base 2 made of polypropylene is transparent, fluorescence detection upon the reaction can be performed externally from the side of the resin base 2.

The reaction chip 1 of the present embodiment is composed of a metal base 3 having a plurality of recess portions 11 and groove portions 12, and a resin base 2 having a plurality of recess portions 6. Therefore, a cheap reaction chip can be realized with a simple configuration. About half of each reaction vessel 4 is composed of a metal base 3 (aluminum). Therefore, the reaction vessel 4 is superior in heat responsiveness. Therefore, a reaction such as PCR or the like can be performed within a short time by controlling the temperature from the side of the metal base 3 using a heater or a Peltier element or the like.

On the surface of the metal base 3 which can be seen through the transparent resin base 2, a layer containing carbon black is provided. Therefore, when the fluorescence detection is performed from the side of the resin base 2, irregular reflection of excitation light is suppressed and detection can be performed with high accuracy. In contrast, it is confirmed that reflection from the metal base 3 causes an unstable detected value in a reaction chip produced without adding carbon black to the anchor layer of the metal base 3. Furthermore, in the present embodiment, although aluminum was used as the metal base 3 and polypropylene was used as the resin base 2, the material to be used can be selected from materials suited for the reaction. Thus, the reaction step can be performed simply and efficiently within a short time.

The technical scope of the present invention is not limited to the above embodiments and various modifications can be made without departing from the scope of the invention. For example, although the groove portions constituting the flow passages were formed only on the metal base in the above embodiment, the groove portion may also be formed on the side of the resin base according to capacity or the like of the liquid reagent, thereby forming the flow passage with both the metal base and the resin base.

Specific constitutions, for example, the shape, the number and configurations of reaction vessels and flow passages, the material and the size of bases, and various techniques used in a series of manufacturing processes are merely exemplary of the invention and appropriate modifications can be made.

### INDUSTRIAL APPLICABILITY

According to the reaction chip of the present invention, a small-sized and cheap reaction chip can be realized with a simple configuration. It is also possible to perform the operation of treating multiple types of specimens with the same reagent using a plurality of reaction vessels and subjecting one type of specimen to a plurality of treatments.

1. A reaction chip comprising:
a first base which contains a metallic base and has a first surface; and
a second base which contains a resin base and has a second surface, wherein
the first surface and the second surface are joined so as to face each other;
the first surface has a plurality of first recess portions and a groove portion located between the plurality of the first recess portions;
the second surface has a plurality of second recess portions located corresponding to the plurality of the first recess portions;
the plurality of the first recess portions and the plurality of the second recess portions are configured so as to form a plurality of reaction vessels; and
the groove portion is configured so as to form a flow passage that communicates among the plurality of reaction vessels with each other.

2. The reaction chip according to claim 1, wherein at least a bottom surface of the second recess portion of the second base has light transmission property.

3. The reaction chip according to claim 1, wherein the first base and the second base are joined via a heat-fusible adhesive layer.

4. The reaction chip according to claim 1, wherein a layer containing a light-absorbing material is provided on the first surface of the first base.

5. The reaction chip according to claim 1, wherein the first base contains a metallic material containing any one of aluminum, copper, silver, nickel, brass and gold.

6. The reaction chip according to claim 1, wherein the first base has a thickness within the range of 50 μm to 300 μm.

7. The reaction chip according to claim 1, wherein the second base contains a resin material containing any one of polypropylene, polycarbonate, and acryl.

8. The reaction chip according to claim 1, wherein the second base has a thickness within the range of 50 μm to 3 mm.

9. A method for producing a reaction chip, comprising:
forming, on a first surface of a first base containing a metal, a plurality of first recess portions which constitutes a portion of each of a plurality of reaction vessels, and a groove portion constituting a portion of a flow passage which communicates among the plurality of reaction vessels;
forming a plurality of second recess portions which constitutes a second portion of each of the plurality of the reaction vessels on a second surface of a second base containing a resin;
fixing a reagent to either the first recess portion or the second recess portion;
joining the first surface and the second surface so as to face each other to form the plurality of the reaction vessels and the flow passage;
filling the reaction vessel with a liquid reagent through the flow passage; and
occluding the flow passage through plastic deformation of the groove portion of the first base, thereby sealing the plurality of reaction vessels.

10. The method for producing a reaction chip according to claim 9, wherein the first surface includes a layer containing a light-absorbing material, and a heat-fusible adhesive layer;
the second base contains a resin material having light transmission properties; and
the first surface and the second surface are arranged so as to contact while facing each other, and then the first base and the second base are joined by irradiating with a laser beam from the side of the second base.

11. The method for producing a reaction chip according to claim 9, wherein the first recess portion and the groove portion are formed by press forming or drawing process.
